(19) United States
(12) Patent Application Publication
(10) Pub. No.: US 2013/0324128 A1
(43) Pub. Date: Dec. 5, 2013

(54) SLEEPING CORE NETWORK NODES FOR ENERGY SAVING IN 3G NETWORKS

(71) Applicants: Masahide Murakami, Tokyo (JP); Anand Raghawa Prasad, Tokyo (JP); Xiaowei Zhang, Tokyo (JP); Shingo Shiga, Tokyo (JP)

(72) Inventors: Masahide Murakami, Tokyo (JP); Anand Raghawa Prasad, Tokyo (JP); Xiaowei Zhang, Tokyo (JP); Shingo Shiga, Tokyo (JP)

(73) Assignee: NEC Corporation

(21) Appl. No.: 13/985,706

(22) PCT Filed: Dec. 5, 2011
(86) PCT No.: PCT/JP2011/078636

§ 371 Date: Aug. 15, 2013

(30) Foreign Application Priority Data
Feb. 24, 2011 (JP) 2011-038779

(51) Int. Cl. H04W 52/02

(52) U.S. Cl. CPC H04W 52/0203
USPC 455/436

(57) ABSTRACT

SGSNs in the same pool-arca share their resource information by using O&M messages or GTP-C messages. At least one of the SGSNs (Sleeping SGSN) decides to sleep (shut down or run in a low power state), based on the resource information. Then the Sleeping SGSN sends a power down notification to the connected RNC/BSC and SGSNs, thereby preventing the RNC/BSC from selecting the Sleeping SGSN for new connection and handovers, and transferring the load on the Sleeping SGSN to other SGSNs.

### TECHNICAL FIELD

The present invention relates to energy saving for Core Network (CN) in 3rd Generation (3G) networks.

### BACKGROUND ART

Mobile coverage across the globe is growing at a rapid pace and now covers the majority of the Earth's population. With more and more people accessing the network, the power consumption created by the mobile operators may become a heavy burden to the environment and needs consideration. Energy saving equipments and mechanisms are needed to reduce the energy consumption to prevent further pollution to the environment.

A mechanism for the efficient use of mobile CNs is provided in this invention. Since the load upon mobile core networks moves according to human activities, it can easily be speculated that the CN will have a lower load during night time. By making unused nodes “sleep” during those hours, the total power consumption of the CN can be decreased.

### CITATION LIST

### Non Patent Literature

NPL 1: 3GPP TS 23.251, “Network Sharing; Architecture and functional description (Release 10)”, V10.0.0, December 2010, pages 7-8, clause 4.1

NPL 2: 3GPP TS 23.236, “Intra-domain connection of Radio Access Network (RAN) nodes to multiple Core Network (CN) nodes (Release 10)”, V10.2.0, December 2010, page 12, clause 4.5a.1

NPL 3: GISFI, GE-20100020, “Greening the mobile core network”, December 2010

### SUMMARY OF INVENTION

### Technical Problem

Current standards do not provide means to shutdown nodes with active calls. The mechanism may provide means to shutdown nodes with no calls, but if there are long time connections (e.g video steaming) on the node, it may take time for that node to shutdown.

This invention gives methods to solve this problem by using handover mechanisms to transfer active calls to different nodes, enabling a shorter time to sleep.

Note that as related technologies, Network Sharing is depicted in Non Patent Literature (NPL) 1. Intra-domain connection of Radio Access Network nodes to multiple Core Network nodes is depicted in NPL 2. Sleeping EPC is depicted in NPL 3.

### Solution to Problem

The mobile network consumes energy even in time periods when no users or fewer users are using the network (e.g. night time). In order to cut unneeded power consumption, this invention proposes that CN nodes “sleep (shuts down or runs in a low power state)”. Here, we define a sleeping CN node for the Packet Switched (PS) network, i.e. the sleeping SGSN (Serving GPRS (General Packet Radio Service) Support Node).

There are included novelty means for SGSNs sharing their resource information by using operation and maintenance (O&M) or GPRS tunneling protocol's C-plane (GTP-C) messages, for triggering Radio Network Controller (RNC)/Base Station Controller (BSC) relocation by Power Down Notification messages, and for RNC/BSCs being able to identify resources that “relocation required”/“relocation request” were sent/received belong to the same call.

### Advantageous Effects of Invention

According to the present invention, the following effects can be achieved.

1. Operators will be able to shutdown or lower the power of unused network nodes. Since this will achieve lower power consumption, operators can realize an eco-friendly system.

2. Operators will be able to scale the size of their CN dynamically according to the mount of user's accessing network.

### BRIEF DESCRIPTION OF DRAWINGS

FIG. 1 is a graph chart showing GHG emission of the Mobile communications sector in 2020.

FIG. 2 is a block diagram showing Basic Configuration of a 3GPP Access Network.

FIG. 3 is a block diagram showing Basic Configuration of LTE network.

FIG. 4 is a block diagram showing Gateway Core Network configuration for Network Sharing.

FIG. 5 is a block diagram showing Sleeping core network node operation.

FIG. 6 is a sequence diagram showing a Detach/Attach method which is applicable for IDLE mode conditions.

FIG. 7 is a sequence diagram showing a Re-routing method which is applicable for CONNECTED mode conditions.

FIG. 8 is a block diagram showing a configuration example of a core network node according to an exemplary embodiment of the present invention.

### DESCRIPTION OF EMBODIMENTS

Hereafter, an exemplary embodiment of a CN node according to the present invention, and a mobile communication system to which this CN node is applied will be described with reference to the drawings. In the 3GPP based network where Iu-flex is available, a group of RAN (Radio Access Network) nodes inside a common pool-area can be connected to a group of CN nodes. Every RAN node inside the same pool-area can be controlled by any CN node looking over that pool-area. The CN nodes will not be fully operational at certain times of the day, and the total amount of unused resources in the pool-area may exceed the capacity of a CN node. In these cases a specific CN node may decide to pass its load to another CN node (an active CN node) and then shutdown or turn down the power consumption (e.g. entering a standby mode or a hibernation mode). Here, we focus on the PS network.

### [Sleeping SGSN]

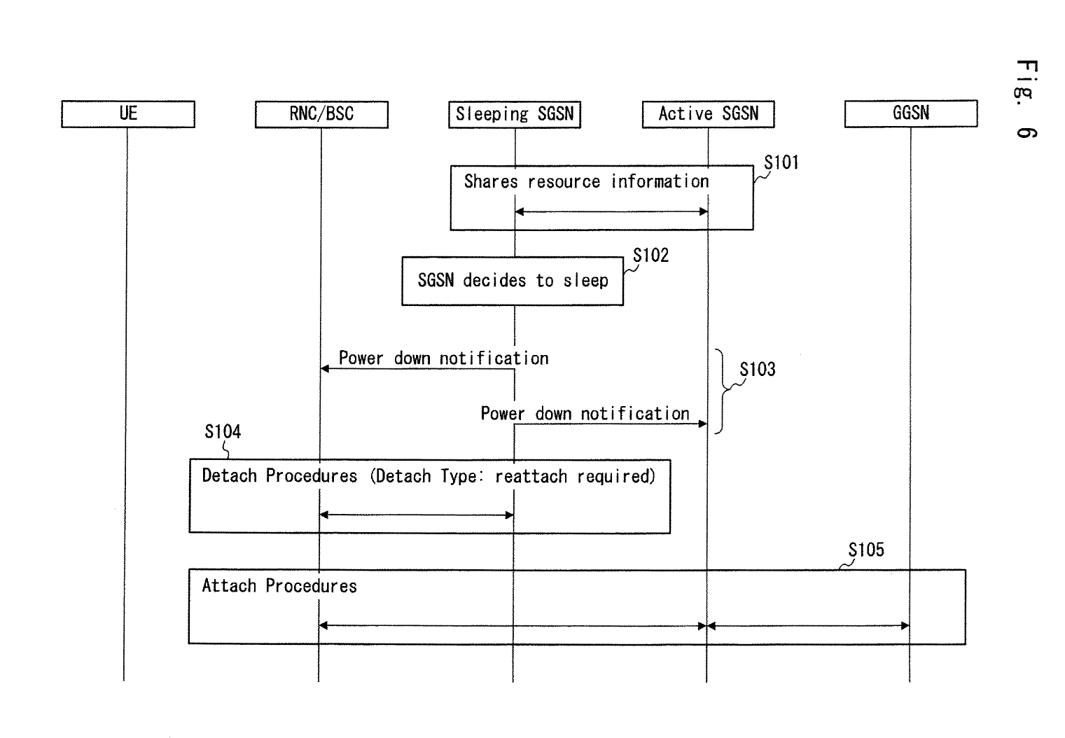

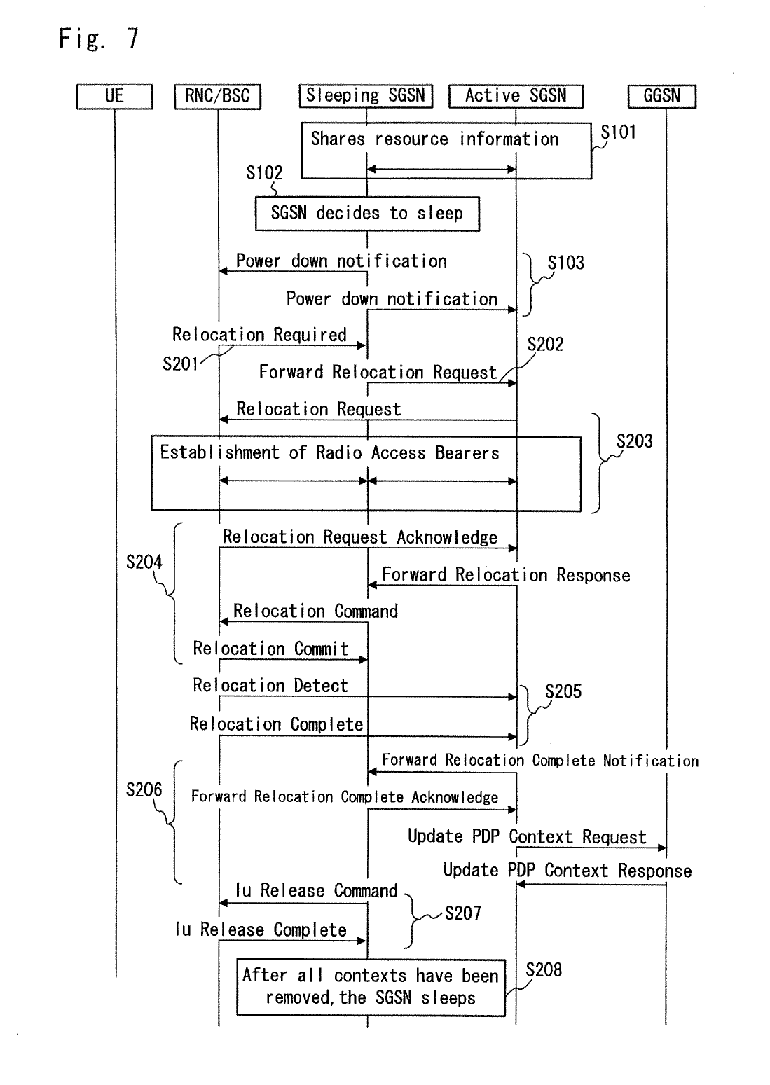

Before falling asleep, a “sleepy” SGSN or the operator will check the amount of open resources of other active SGSN nodes inside the same PS-pool-area (Step S101 shown in each of FIGS. 6 and 7). This can be accomplished by using O&M messages or by defining messages over the GTP-C protocol. In more detail, the SGSNs communicate with each other by use of the O&M or GTP-C messages, thereby sharing information on open resources (hereinafter, sometimes referred to as “resource information”) between the SGSNs. Having done this, the sleepy SGSN or the operator would know if there is an adequate amount of resources for the sleepy SGSN to transfer its load and sleep (Step S102 shown in each of FIGS. 6 and 7).

Once the sleepy SGSN decides to sleep, it would declare that it is going to sleep by sending a power down notification to the connected RNC/BSC and SGSNs in the same pool (Step S103 shown in each of FIGS. 6 and 7). This prevents the RNC/BSC from selecting the sleepy SGSN for new connections and handovers.

Next, the sleepy SGSN would transfer its load to other SGSNs in the same PS-pool-area. There are two methods available: one would be to requesting the User Equipment (UE) to detach/attach to the network (the RNC would not re-select the sleepy SGSN from the power down notification) or re-routing the connection to a new SGSN.

### <Detach/Attach Method>

FIG. 6 describes the detach/attach method. This method is most applicable for IDLE mode conditions. It can be also used for CONNECTED mode conditions but may cause interruptions to active data transfers. Here, after the SGSN sends the power down notification, it would send detach requests for each of its connections to the UE with “detach type: reattach required”. The detach process will be conducted between the related nodes (Step S 104). After that the UE will trigger an attach procedure. Here, the RNC/BSC will know that the sleeping SGSN is no longer in use, will select an active SGSN for the attach request (Step S105).

### <Re-Routing Method>

FIG. 7 describes the re-routing method. This method is most applicable for CONNECTED mode conditions for it partly uses handover methods to forward UE contexts from sleepy SGSNs to active SGSNs. There will be no interactions between the UE and RNC/BSC for there will he no change in the selected RNC/BSC. The power down notification triggers the RNC/BSC to initiate a relocation procedure by sending a relocation message to the sleepy SGSN (Step S201). The sleepy SGSN will select an active SGSN to switchover thereto and sends a forward relocation request to the active SGSN (Step S202). The active SGSN will send a relocation request to the RNC/BSC to establish a new Radio Access Bearer (RAB). The RNC/BSC will identify that the relocation request is for one of its current resources and will prepare for redirecting the communication (not all resources required for handovers will be allocated) (Step S203). After the RAB is established, it will respond to the forward relocation request and the sleepy SGSN will trigger the relocation command to the RNC/BSC (Step S204). The RNC/BSC will send a relocation detect message to the active SGSN and also send a relocation complete message later (Step S205). The active SGSN will send forward relocation complete notification to the sleepy SGSN and will update the Packet Data Protocol (PDP) context to redirect U-plane data through the active SGSN (Step S206). Finally, the sleepy SGSN will be able to cut the Iu connection with the RNC/BSC (Step S207).

After all connections has been removed from the sleepy SGSN, it can shutdown or turn to a low power mode, making it a Sleeping SGSN (Step S208). When the Sleeping SGSN by a given timer or manually by an operator, it would send power up notification messages by GTP or O&M messages to show it is online again.

Based on the above description, the following document will be submitted to Global ICT Standardization Forum for India (GISFI).

### 1. Abstract

Mobile communications is a fast growing sector not only in India but the whole world. It can help bring down the Green House Gas (GHG) emission of other sectors, but will increase the amount of emission of the mobile communication sector itself along with its growth. In order to assure sustainable growth of this sector, means to alleviate GHG emissions must be proposed. This document is an update of a previous proposal GE-20100020 [1], and also focuses on the core network part of mobile communications. We propose this document to be accepted for the deliverable 2 of Green Energy activity, “Study on potential enhancements of ICT (Information and Communications Technology)”.

### 2. Introduction

Utilizing ICT can be considered as an effective method to decrease the GHG emissions of other sectors (as discussed in GE-20100011 [2]). However, it is difficult for ICT to reduce GHG emissions of the ICT sector itself. Therefore, further methods to decrease GHGs must be considered for a “green” ICT. This document will focus on the core network of the mobile communication part of ICT.

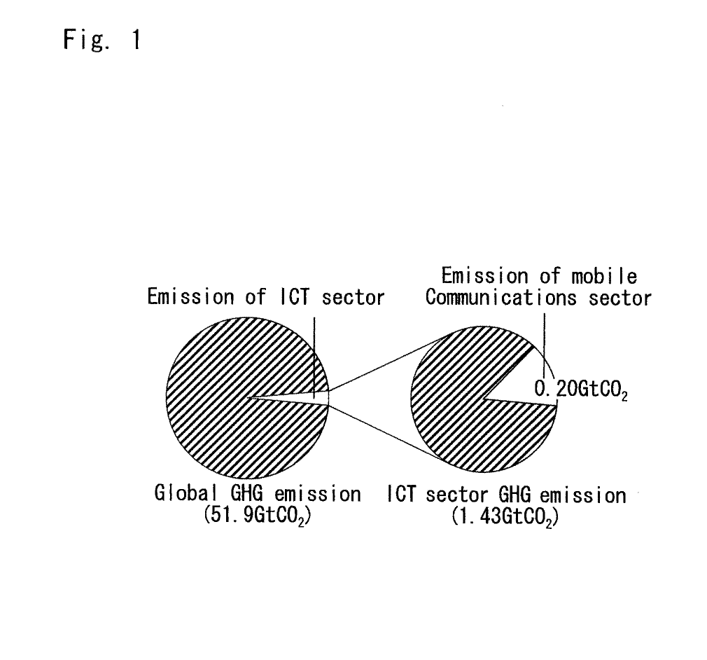

According to SMART2020 [3], it is said that mobile communications will emit 201 Mega-tons of GHG into the earth's atmosphere by 2020 (see FIG. 1). Mobile communication is consisted of mobile terminals, Radio Access Networks (RAN), and core networks. Even though the majority of these emissions are from the RAN, the core network should take measures to reduce its energy consumption and GHG emission.

In this document, we first discuss how the current core network is structured for 3G and LTE. Second, we discuss what elements are missing from the current networks. Finally, we propose a high level solution that will efficiently reduce the amount of GHG emission.

### 3. Current Analysis

Before we discuss how we can reduce the amount of GHG emission for the core network, it is important to know the current architecture of the network. In this section, we will take conventional 3rd Generation networks and Long Term Evolution (LTE) networks as examples, and describe measures taken by the 3rd Generation Partnership Project (3GPP) to reduce GHG emission.

### 3.1. Current Status of the Core Networks

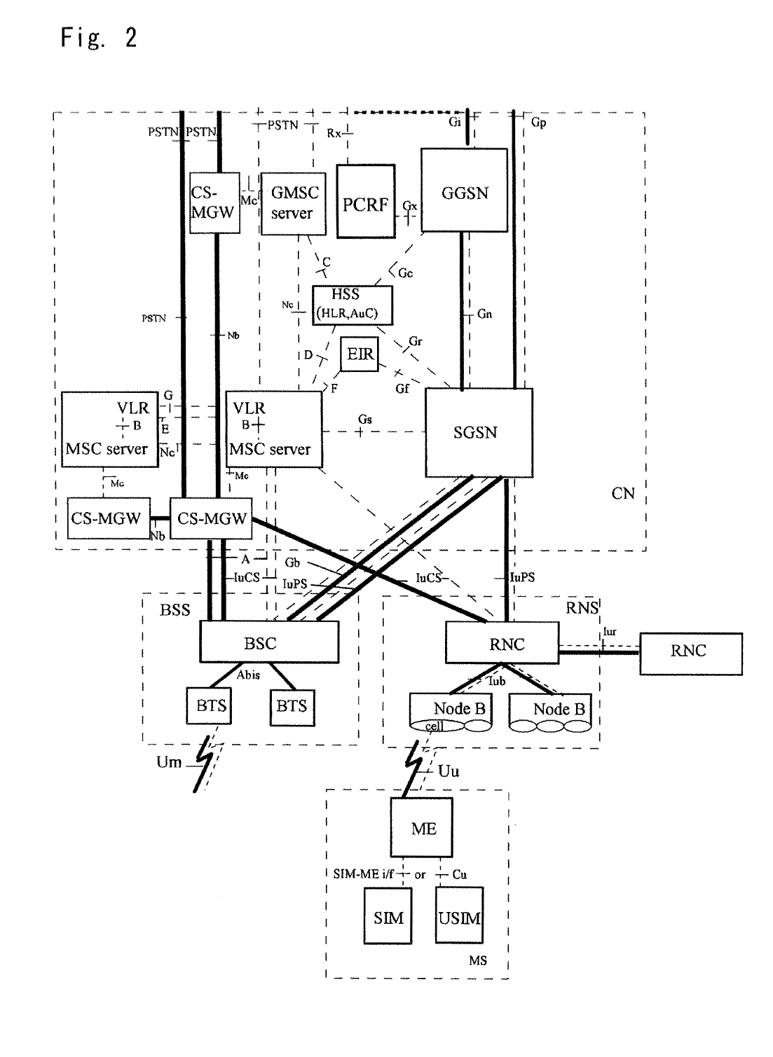

FIG. 2 describes the 3G network architecture [4] (LTE is left out of this picture). The network architecture is consisted of the RAN and the core network. The RAN consists of Radio Network Controllers (RNC) and NodeBs for 3G. Both circuit switched (CS) and packet switched (PS) calls go through the RAN and are directed to different nodes in the core network (i.e. CS is served by the Mobile Switching Centre (MSC), PS is served by the Serving GPRS Support Node (SGSN)). After CS or PS data enter the core network, they are processed and sent to the appropriate destinations.

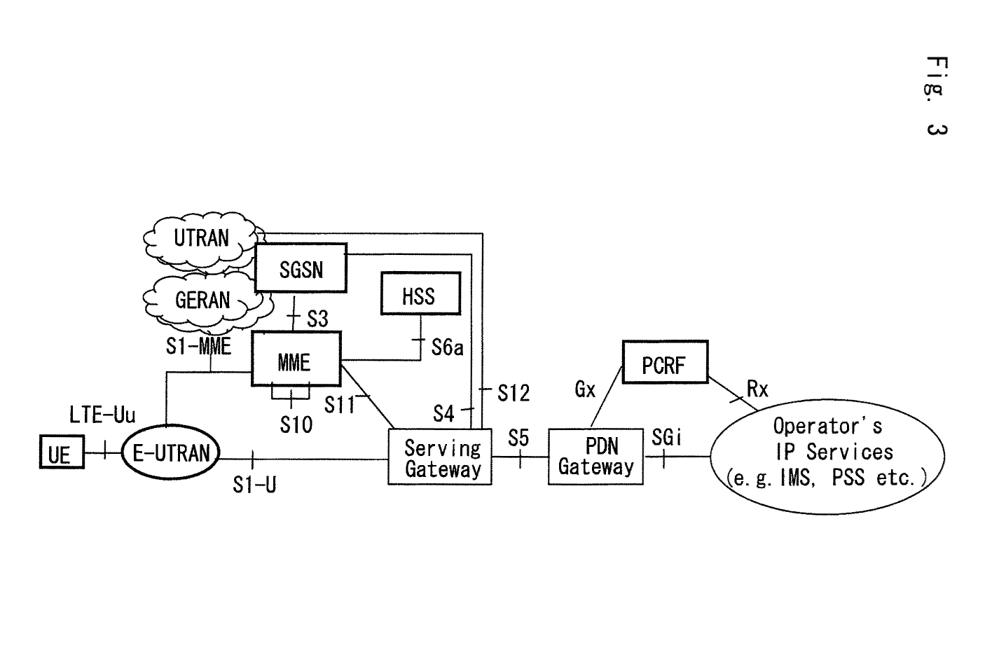

FIG. 3 describes the LTE network [5]. Unlike conventional 3G networks, the LTE net work only handles PS services. The RAN consists of eNodeBs and their controls are handled by Mobility Management Entities (MME). The Serving Gateway (S-GW) and P-GW (Packet Data Network Gateway) handle the user plane traffic and the MMEs handle the control packets. In the case where circuit switched services are needed, it is possible to fallback to the 3G network if coverage is available.

### 3.2. Current Measures for Green Core Networks

One method being standardized in 3GPP that results in a Green Core Network would be network sharing (TS 23.251 [6]). Network sharing enables different operators to share the same RAN and nodes at the edge of the core network. This reduces over lapping equipment covering the same area. It results in cutting deployment and operation costs for operators as it gives green effect in having less equipment and power consumption. However, when there already is an existing network, operators will end up throwing away their equipment. Thus this solution may only be attractive to operators when applying it for deployment in new areas.

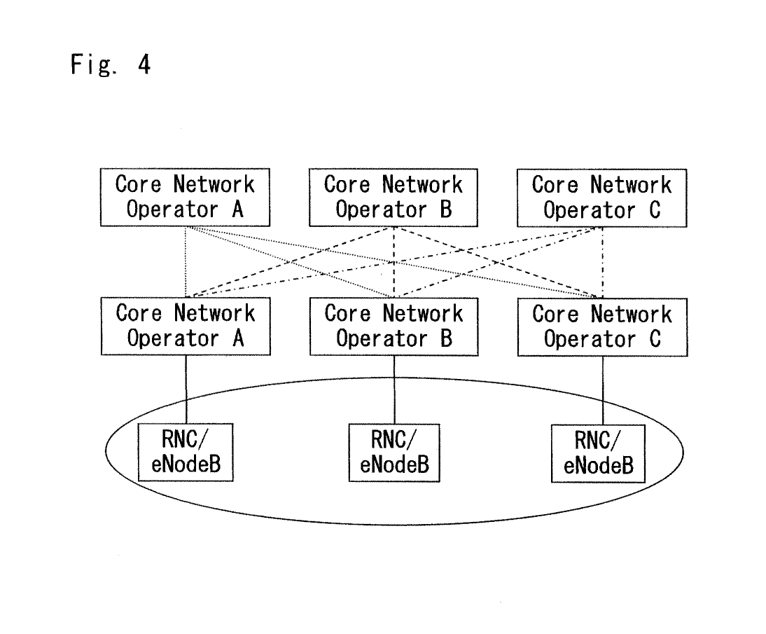

FIG. 4 shows the Gateway Core Network (GCNW) configuration of a conventional 3GPP network. The SGSNs/MSCs/MMEs are shared between operators at the edge of their core networks, and RNCs/eNodeBs are shared for RAN.

### 4. Gap Analysis

Additional methods for saving power in the core network must also be considered. First, we will discuss the problems that cannot be solved with the current solution. Then we will elaborate on the potential solutions to cope with the problem.

### 4.1. Areas Needing Additional Saving

The current network sharing solution given by the 3GPP is very beneficial as a method to cut equipment and operation costs. However, there are issues that still need to be handled, creating more areas where power reduction is possible. There also would be demands from standardization aspects to cope with the problem.

One significant issue would be the power used in systems that are not being used constantly throughout the day. For example, in commercial areas, the system is in its busiest state during the day time, and the network load will start decreasing after business hours. Residential areas will probably have a different peak hour, and most areas would have a significantly lower load during the smaller hours of the day.

Current systems do not change their processing capacity according to their load. They are built based on the busy hour call attempts (BHCA) and are operated so that it can process its maximum capacity during any time of the day. This leads to unneeded power consumption making its countermeasure a requirement in achieving a green core network.

### 4.2. High Level Proposal

In order to solve the requirement discussed in the previous section, a new solution is needed. The requirement in the last chapter was to cut power consumption when the system has smaller loads compared with its maximum capacity. Some potential solutions for cutting power consumption are: lowering CPU performance, putting the system in suspended/standby mode, and powering off the system. These apply for parts of the network not being used (in this case, the SGSN for 3G, and the MME and S-GW for LTE). However, these solutions may create communication problems when the target node is accessed from other nodes in the network. In order to power down nodes in the network, the negotiation between nodes would be crucial.

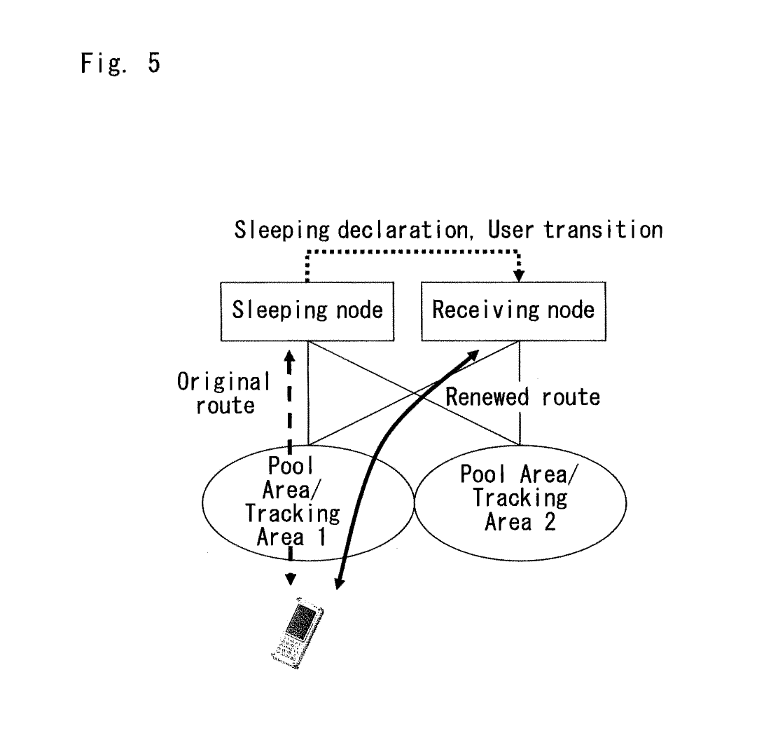

FIG. 5 presents a high level architecture of a system that enables core nodes to power down (or to enter a lower powered state that does not handle actual transactions). First, when a certain core node (SGSN, MME or S-GW) decides to “sleep” for various reasons (e.g. small number of signalling traffic in midnight, lack of users, etc), it will send out “sleeping declarations” to connected nodes. If the core node that receives the message is possible to handle all the traffic covered by the sleeping node, the sleeping node handovers all of its transactions to the receiving node. Thus, the users' traffic remains connected to the network via a different node. Since now the sleeping node has no transactions left, it can be turned off or into a low powered state. The sleeping node can be “waked up” by a given timer or a wake up message.

### 5. Conclusions

Throughout this document, we have discussed how the core network may be using power inefficiently. As the mobile industry is a fast growing sector in India, there must be measures to avoid increasing GHG emissions. We proposed a high level architecture that will help eliminate unneeded energy consumption of the core network. We propose that this document is accepted for deliverable 2 of Green Energy activity, “Study on potential enhancements of ICT”.

### 6. References

[1] GISFI, GE1-20100020, Greening the mobile core network, December 2010.
[2] GISFI, GE1-20100011, Making things Green with ICT, September 2010.
[3] The Climate Group: Global e-Sustainability Initiative report, “Smart 2020 Enabling Low Carbon Economy in the Information Age”, 2008, <http://www.smart2020.org/publications/>.
[4] 3GPP, TS 23.002 v9.1.0, Network Architecture, September 2009.
[5] 3GPP, TS 23.401 v9.6.0, General Packet Radio Service (GPRS) enhancements for Evolved Universal Terrestrial Radio Access Network (E-UTRAN) access, September 2010.
[6] 3GPP, TS 23.251 v 9.2.0, Network sharing; Architecture and functional description, March 2010.

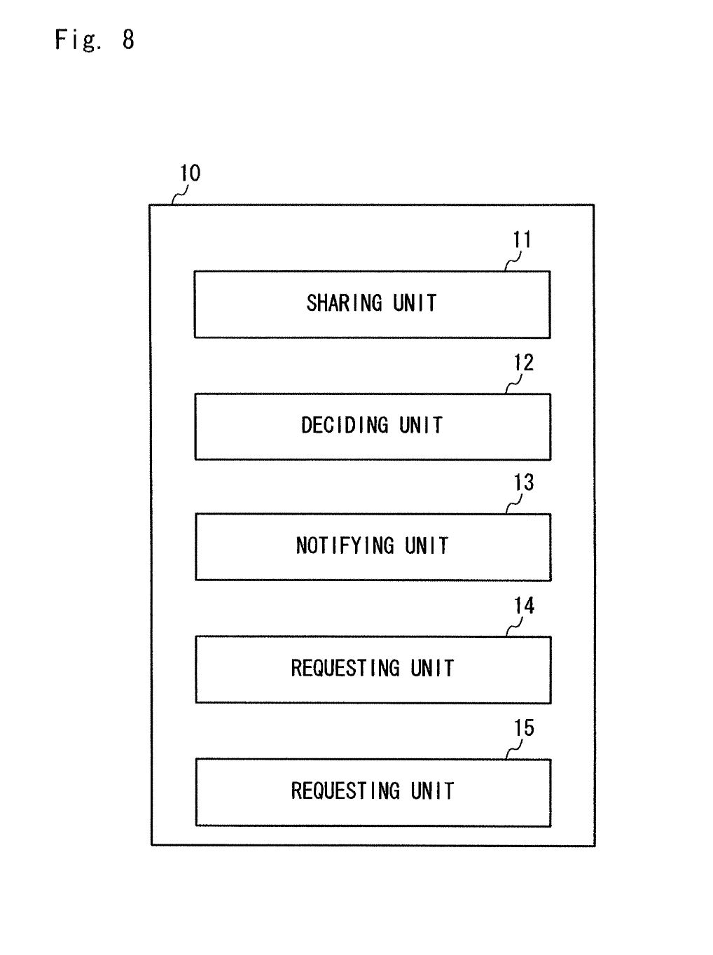

Next, a configuration example of the CN node according to this exemplary embodiment (i.e., the Sleeping SGSN shown in FIGS. 6 and 7) will be described with reference to FIG. 8.

As shown in FIG. 8, an SGSN 10 includes a sharing unit 11, a deciding unit 12, a notifying unit 13, and requesting units 14 and 15.

The sharing unit 11 shares the resource information between other SGSNs (i.e., active SGSNs), for example, by using the above-mentioned O&M or GTP-C messages. The deciding unit 12 decides whether or not to make the SGSN 10 sleep based on the resource information as described above. The notifying unit 13 transmits the power down notification to the RNC/BSC and the active SGSNs, when the SGSN 10 sleeps. The requesting unit 14 performs processing according to the above-mentioned detach/attach method. Specifically, the requesting unit 14 transmits the detach request message with the detach type which indicates “reattach required” to a UE attached to the SGSN 10 through the RNC/BSC. The requesting unit 15 performs processing according to the above-mentioned re-routing method. Specifically, the requesting unit 15 receives from the RNC/BSC the relocation message (Relocation Required message shown at Step 5201 in FIG. 7) as a response to the power down notification. Then, the requesting unit 15 transmits the Forward Relocation Request message to one of the active SGSNs.

These units 11 to 15 can be configured by, for example, interfaces which communicate with other SGSNs and the RNC/BSC, and a controller which controls these interfaces to execute the processes shown in FIGS. 6 and 7 or processes equivalent thereto.

Note that the present invention is not limited to the above-mentioned exemplary embodiment, and it is obvious that various modifications can be made by those of ordinary skill in the art based on the recitation of the claims.

This application is based upon and claims the benefit of priority from Japanese patent application No. 2011-038779, filed on Feb. 24, 2011, the disclosure of which is incorporated herein in its entirety by reference.

The whole or part of the exemplary embodiment disclosed above can be described as, but not limited to, the following supplementary notes.

(Supplementary Note 1)

Methods to decide which core node should sleep

There are several ways to decide the sleeping node. An operator can decide the sleeping node by checking SGSN resources via an O&M terminal through pre-defined O&M messages. Otherwise, SGSN can check resources for themselves by checking resources through defining GTP-C or O&M messages.

(Supplementary Note 2)

Power down notification and power up notification messages

Power down/up notification messages can be sent by defining messages on the RANAP (Radio Access Network Application Part), GTP-C, and O&M messages. Power up messages can be triggered by a given timer, disasters, overload messages from other SGSNs/RNCs, or manually by an operator.

(Supplementary Note 3)

Power Down Preparation

In order for the sleepy node to power down efficiently, it will block new connections, and only accept disconnect or handover related messages. Once all the user connections are transferred or disconnected, the sleeping node will power down.

(Supplementary Note 4)

Re-use of Serving RNS (Radio Network Subsystem) relocation procedures

This procedure is different from serving RNS relocation for the source RNC and the target RNC are the same RNC. Therefore, the RNC will be able to omit unneeded inter RNC messages and prevent itself from securing unneeded resources. The RNC will he able to specify the relocation messages belong to the same call by comparing the relocation required and relocation request messages that are sent/received at the RNC.

### REFERENCE SIGNS LIST

10 SGSN
11 SHARING UNIT
12 DECIDING UNIT
13 NOTIFYING UNIT
14, 15 REQUESTING UNIT

1. A mobile communication system comprising a plurality of nodes that form a core network,
wherein at least one of the plurality of nodes is configured to:
decide to sleep, based on resource information shared between the plurality of nodes;
notify different nodes among the plurality of nodes and a node forming a RAN (Radio Access Network) that the node itself sleeps, when it is decided to make the node itself sleep; and
request, upon receiving a response to the notification from the node forming the RAN, any one of the different nodes to establish connection with the node forming the RAN as a substitute for the node itself,
wherein the response comprises a Relocation Required message used in handover procedure,
wherein the request is performed by transmitting a Forward Relocation Request message used in the handover procedure.

2. A node that forms a core network in a mobile communication system, the node comprising:
a first unit that shares resource information between one or more different nodes that form the core network;
a second unit that decides whether or not to make the node itself sleep, based on the resource information;
a third unit that notifies the different nodes and a node forming a RAN (Radio Access Network) that the node itself sleeps, when the second unit decides to make the node itself sleep; and
a fourth unit that requests, upon receiving a response to the notification from the node forming the RAN, any one of the different nodes to establish connection with the node forming the RAN as a substitute for the node itself,
wherein the response comprises a Relocation Required message used in handover procedure,
wherein the fourth unit performs the request by transmitting a Forward Relocation Request message used in the handover procedure.

3. The node according to claim 2, wherein the second unit decides to make the node itself sleep when the resource information indicates that any one of the different nodes has an adequate mount of resources for transferring a load on the node itself.

4-5. (canceled)

6. The node according to claim 2, further comprising:
a fifth unit that requests a UE (User Equipment) that is attached to the node itself through the RAN to re-attach to any one of the different nodes, prior to making the node itself sleep.

7. The node according to claim 6, wherein the fifth unit performs the request for the UE by transmitting a detach request message with a detach type indicating re-attach required.

8-9. (canceled)

10. A method for energy saving in a mobile communication system, the method comprising:
deciding to cause at least one of a plurality of nodes that form a core network in the mobile communication system to sleep, based on resource information shared between the plurality of nodes;
notifying different nodes among the plurality of nodes and a node forming a RAN (Radio Access Network) that the at least one of nodes sleeps, when it is decided to cause the at least one of nodes to sleep: and
requesting by the at least one of nodes, when a respsonse to the notification is received at the at least one of nodes from the node forming the RAN, any one of the different nodes to establish connection with the node forming the RAN as a substitute for the at least one of nodes,
wherein a Relocation Required message used in handover procedure is received as the response,
wherein the request is performed by transmitting a Forward Relocation Request message used in the handover procedure.

11. A method of controlling a node that forms a core network in a mobile communication system, the method comprising:
sharing resource information between one or more different nodes that form the core network;
deciding whether or not to make the node itself sleep, based on the resource information;
notifying the different nodes and a node forming a RAN Radio Access Network that the node itself sleeps, when it is decided to make the node itself sleep; and
requesting, upon receiving a response to the notification from the node forming the RAN, any one of the different nodes to establish connection with the node forming the RAN as a substitute for the node itself,
wherein a Relocation Required message used in handover procedure is received as the response,
wherein the request is performed by transmitting a Forward Relocation Request message used in the handover procedure.

12. The method according to claim 11, wherein it is decided to make the node itself sleep when the resource information indicates that any one of the different nodes has an adequate mount of resources for transferring a load on the node itself.

13-14. (canceled)

15. The method according to claim 11, further comprising:
requesting a UE (User Equipment) that is attached to the node itself through the RAN to re-attach to any one of the different nodes, prior to making the node itself sleep.

16. The method according to claim 15, wherein the request for the UE is performed by transmitting a detach request message with a detach type indicating re-attach required.

17-18. (canceled)
